(19) United States
(12) Patent Application Publication
(10) Pub. No.: US 2008/0158863 A1
(43) Pub. Date: Jul. 3, 2008

(54) Electrical Candle with Micro-Control Means

(76) Inventor: Sam Tsai, Taipei City (TW)

Correspondence Address: RABIN & Berdo, PC, 1101 14TH STREET, NW, SUITE 500, WASHINGTON, DC, 20005, US

(21) Appl. No.: 11/617,034

(22) Filed: Dec. 28, 2006

(51) Int. Cl. F21S 4/00; H01R 33/02; H01R 33/46

(52) U.S. Cl. 362/183; 362/392; 362/653

(57) ABSTRACT

The electrical candle with micro-control means comprising a main body and a base body. The main body includes a shell and a circuit module, and the shell including a flame-shaped cover member and a plurality of holes. The circuit module, inside the shell, includes an illuminant and a micro switch. The base body includes a hollow to contain the main body. The characteristic is that the electrical candle turned on and off by an external force which actuates the micro switch to control power supply. The external force could be airflow-control, voice-control and vibrating so that it is easy for users to utilize the electrical candle. Therefore, the present invention provides a new and improved electrical candle for people to use with more convenience.

### FIELD OF THE INVENTION

The present invention relates to an illumination device, and more particularly, to an electrical candle with micro-control means.

### BACKGROUND OF THE INVENTION

A conventional candle usually emits light by burning its wick, and may cause some deficiencies, for examples after burning the wick, consequently carbon dioxide produced and the air polluted. Besides, sometimes a fire accident occurred when the conventional candle is not set up well.

U.S. Pat. No. 5,601,360 published on Feb. 11, 1997, titled “Plug-in Electrical Candle for a Window Sill” disclosed an electrical candle is in combination with a low-voltage bulb at the top and a pair of prongs at the bottom, and the prongs are engaged to the contacts of the low-voltage socket installed in a window sill. It's not convenient to find a socket set, although the electrical candle could help to decrease the possibility of accidents occurred.

People's Republic of China Patent Publication No. CN2668988 published on Jan. 05, 2005, titled “An Electrical Candle” disclosed a main body shaped as a candle and a circuit composed of an illuminant, a power supply and a switch and set on the main body. The electrical candle emits/extinguishes the light by touching the switch set at the bottom of the main body. It can not be blown out with a puff like the conventional candle.

Although the above-mentioned electrical candles may improve some shortcomings of conventional candles, they are still inconvenient. Therefore, it can be appreciated that there exists a continuing need for a new and improved electrical candle.

### SUMMARY OF THE INVENTION

Accordingly, the main object of the invention is to provide an improved electrical candle with micro-control means, wherein the electrical candle comprises a main body and a base body. The main body includes a shell and a circuit module, and the shell includes a flame-shaped cover member and a plurality of holes. The circuit module, inside the shell, includes an illuminant and a micro switch. The base body includes a hollow that is used to contain the main body. The electrical candle is turned on by an external force actuating the micro switch, and is turned off by actuating the micro switch again.

Moreover, the illuminant, including at least one light-emitting diode, is enclosed in the flame-shaped cover member to form a candle flame appearance as the illuminant is lighted up, and the flame-shaped cover member is made by transparent or translucent materials. The electrical candle with micro-control means is turned on and off by an external force actuated the micro switch, and the external force could be airflow-control, voice-control or vibrating. Preferably, while blowing to the flame-shaped cover member of the electrical candle, the micro switch is actuated by the airflow penetrated the plurality of holes around the cover member. Thus the illuminant in the flame-shaped cover member is turned on, and the cover member utilized the candle looks like a real candle flame.

Besides, the main body further comprises a containing space, which at least one power supply element could be put in, to couple with the circuit module. The power supply element could be a battery. In addition, the main body also comprises a cover plate, coupled with the containing space to prevent the power supply element from dropping out of the containing space.

To achieve the foregoing object, there is provided an improved electrical candle with a micro switch actuated by an external force such as airflow-control, voice-control or vibrating to supply and shut off the power for lighting up and extinguishing the illuminant. Consequently the present invention do not cause air pollutions and fire accidents from burning, and the simple operation also provides more convenience.

### BRIEF DESCRIPTIONS OF THE DRAWINGS

The foregoing aspects, as well as many of the attendant advantages and features of this invention will become more apparent by reference to the following detailed description, when taken in conjunction with the accompanying drawings, wherein:

FIG. 1 illustrates the exploded view of the main body of the preferred embodiment;

FIG. 2 illustrates the perspective view of the main body of the preferred embodiment;

FIG. 3 illustrates the perspective view of the preferred embodiment

FIG. 4 illustrates the schematic view of the circuit module for controlling operation of the illuminant of the preferred embodiment; and

FIG. 5-6 illustrate the perspective views of other embodiments.

### DETAILED DESCRIPTIONS OF THE PREFERRED EMBODIMENT

The foregoing and other objects, features and advantages of the present invention will be more readily understood upon consideration of the following preferred embodiment's description of the invention, taken in conjunction with the following drawing.

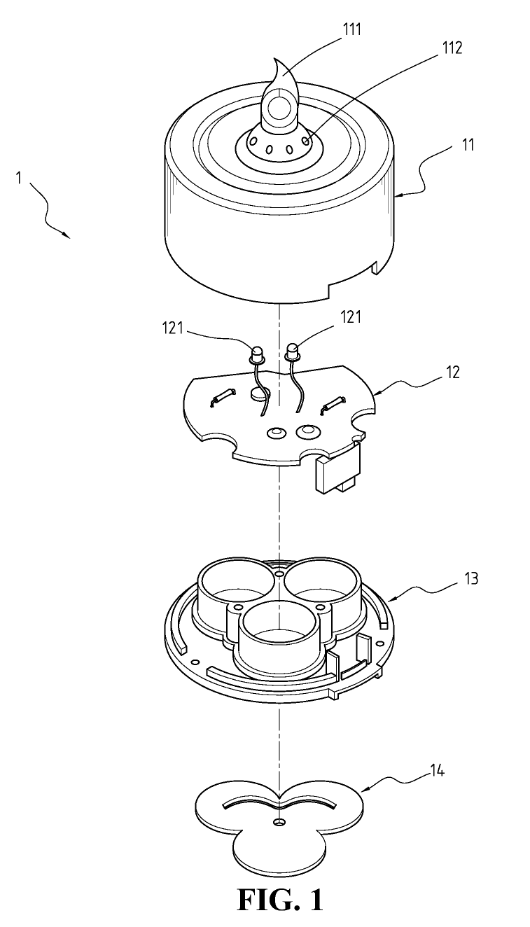

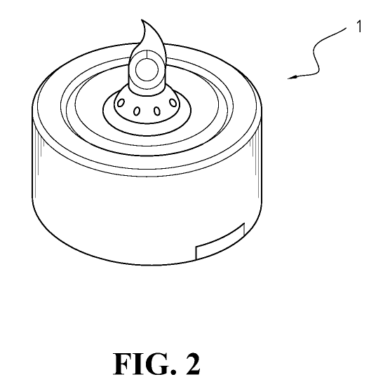

The present invention is to provide an improved electrical candle with micro-control means, wherein the electrical candle comprises a main body 1 and a base body 2. With reference to FIG. 1-2, illustrating the main body 1 includes a shell 11 and a circuit module 12, and the shell 11 including a flame-shaped cover member 111 and a plurality of holes 112. The plurality of holes 112 is set around the flame-shaped cover member 111, and the flame-shaped cover member 111 is made by transparent or translucent materials. The circuit module 12, inside the shell 11, including an illuminant 121 and a micro switch (unshown). The illuminant 121, comprising at least one light-emitting diode, is enclosed in the flame-shaped cover member 111 to form a candle flame appearance as the illuminant 121 is lighted up.

The base body 2 includes a hollow that is used to contain the main body 1. Besides, the main body 1 further comprises a containing space 13, which at least one power supply element could be put in, to couple with the circuit module 12. The power supply element could be a battery. In addition, the main body 1 also comprises a cover plate 14, and the cover plate 14 is coupled with the containing space 13 to prevent the power supply element from dropping out of the containing space 13. In combination with the shell 11, the circuit module 12, the containing space 13 and the cover plate 14 orderly, the main body 1 is assembled.

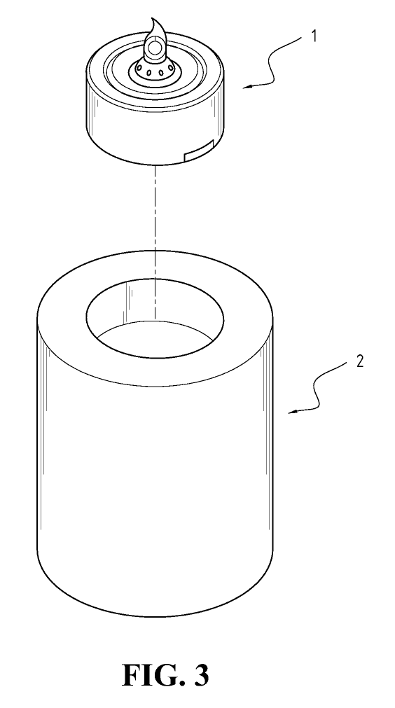

With reference to FIG. 3, illustrating the main body 1 and the base body 2 of the preferred embodiment. After assembled, the main body 1 could be put in the hollow of the base body 2 to form the electrical candle of the present invention.

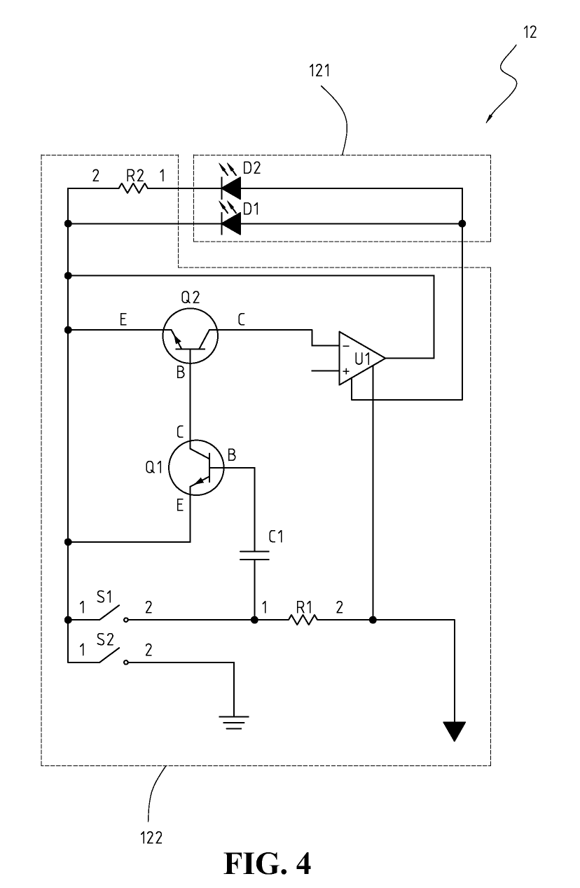

Referring to FIG. 4, the illuminant 121 is connected with the electronic control unit 122 which controls lighting. The illuminant 121 is enclosed in the flame-shaped cover member (unshown) to simulate an opening flame appearance of a conventional candle when the power supplied. In the preferred embodiment, the illuminant 121 comprises two light-emitting diodes indicating D1 and D2. The electronic control unit 122 comprises an electricity supply circuit and a micro switch S1, wherein the illuminant 121 is controlled by the micro switch S1 to supply the electricity. While the micro switch S1 is on, the electric current passed through the first resistance R1 and the capacitance C1 to the base of the first transistor Q1. The collector of the first transistor Q1 connects to the base of the second transistor Q2, and the collector of the second transistor Q2 connects to the inverting input terminal of the first amplifier U1. At the same time, the negative voltage input terminal of the first amplifier U1 connects with the anodes of the light-emitting diodes D1 and D2. The cathodes of the light-emitting diodes D1 and D2 could connect to one end of the plug-in switch S2 directly while the other end of the plug-in switch S2 grounds. On the other hand, the cathodes of the light-emitting diodes D1 and D2 could also connect to one end of the plug-in switch S2 through the second resistance R2 while the other end of the plug-in switch S2 grounds. Moreover, the output terminal of the first amplifier U1, the emitter of the first transistor Q1 and the emitter of the second transistor Q2 ground through the plug-in switch S2. The one end of the micro switch S1 connects to the first resistance R1 and the capacitance C1, and the other end grounds through the plug-in switch S2, too. In the preferred embodiment, the micro switch S1 is at the position corresponding to the plurality of holes. While blowing to the flame-shaped cover member of the electrical candle, airflow penetrates the plurality of holes so that the micro switch S1 is actuated, and the illuminant is lighted up. In addition to airflow-control, the micro switch could be actuated via voice-control and vibrating to turn on and turn off the electrical candle. The electricity circuit is not limited to the form mentioned above, and it could be other forms of circuits to supply power to the illuminant.

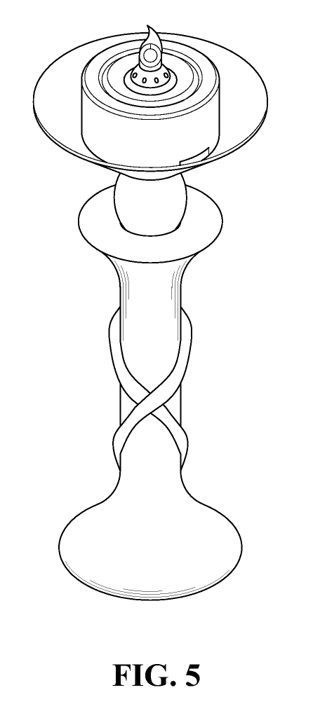

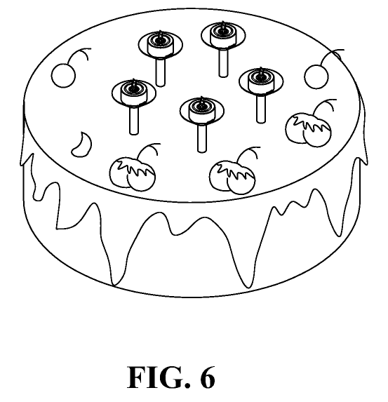

With reference to FIG. 5 and FIG. 6, the use of the electrical candle is not limited to the style mentioned above. If the base body is not cylinder, it could be some kind of candleholder as illustrated in FIG. 5. Moreover, the main body can be used without the base body. For example, it can be used independently on a birthday case as illustrated in FIG. 6. It can be blown out with a puff like the conventional candle, and we do not have to worry about wax oil dropping on the cake and the air pollution after burning.

Preferably, the micro switch of the electrical candle is set on the circuit module and it is set at the position corresponding to the holes. While blowing to the flame-shaped cover member, the airflow penetrates the holes to actuate the micro switch, and then the electrical candle is turned on. In the same way, while blowing to the flame-shaped cover member again, the airflow penetrates the holes to actuate the micro switch to shut down the power supply, thus the electrical candle is turned off.

In the preferred embodiment, an improved electrical candle with a micro switch could be actuated by an external force such as airflow-control to supply and shut off the power for lighting up and extinguishing the illuminant. Moreover, an actuated external force could be voice-control or vibrating way to illuminate and extinguish the candle. Therefore, the present invention provides a new and improved electrical candle for people to use with more convenience.

While the invention has been particularly shown and described with reference to the preferred embodiments thereof, these are, of course, merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. An electrical candle with micro-control means comprising a main body and a base body, wherein the main body including:
a shell including a flame-shaped cover member and a plurality of holes;
a circuit module, inside on the shell, including an illuminant and a micro switch;
the base body including a hollow to contain the main body;
the characteristic is that the electrical candle turned on and off by an external force actuating the micro switch.

2. The electrical candle of claim 1, wherein the flame-shaped cover member is made by transparent or translucent materials.

3. The electrical candle of claim 1, wherein the plurality of holes are set around the flame-shaped cover member.

4. The electrical candle of claim 1, wherein the illuminant is enclosed in the flame-shaped cover member.

5. The electrical candle of claim 1, wherein the illuminant comprises at least one light-emitting diode.

6. The electrical candle of claim 1, wherein the main body further comprises a containing space to couple with the circuit module.

7. The electrical candle of claim 1, wherein the main body further comprises a cover plate to couple with the containing space.

8. The electrical candle of claim 1, wherein the external force to actuate the micro switch could be airflow-control, voice-control or vibrating.

9. The electrical candle of claim 6, wherein the containing space contains at least one power supply unit.

10. The electrical candle of claim 9, wherein the power supply unit could be a battery.
